(19) United States
(12) Patent Application Publication
(10) Pub. No.: US 2014/0220790 A1
(43) Pub. Date: Aug. 7, 2014

(54) Electrical Hinge Assembly and Electric Device using the Same

(71) Applicants: Chung-Yu Lee, New Taipei City (TW); Shun-Yu Hung, New Taipei City (TW)

(72) Inventors: Chung-Yu Lee, New Taipei City (TW); Shun-Yu Hung, New Taipei City (TW)

(21) Appl. No.: 13/756,580

(22) Filed: Feb. 1, 2013

(51) Int. Cl. H01R 35/00

(52) U.S. Cl. CPC H01R 35/00
USPC 439/31

(57) ABSTRACT

The invention relates to an electrical hinge assembly and an electric device using the same. The electric device includes the electrical hinge assembly, a first slab and a second slab. The electrical hinge assembly includes a first holder and a second holder. The first holder comprises a shaft body. The shaft body includes a central shaft and a conductive layer. The conductive layer covers the central shaft. The second holder comprises a tube body. The tube body surrounds the shaft body capable of being rotated. The first slab is fastened with the first holder and comprises a first electrical component. The first electrical component is electrically connected to an end of the conductive layer. The second slab is fastened with the second holder and comprises a second electrical component. The second electrical component is electrically connected to another end of the conductive layer.

### BACKGROUND OF THE INVENTION

1. Field of the Invention

The present invention relates to a hinge assembly and an electric device using the same. More particularly, the present invention relates to an electrical hinge assembly that has a conductive layer and an electric device using the same.

2. Description of the Related Art

Nowadays, an electric device especially for a portable electric device, like a laptop, generally has an electrical hinge connection between a first slab and a second slab. The first slab has a first electrical component which includes, for example, a computer related component, a battery and an input device like a keyboard. The second slab has a second electrical component which includes, for example, a liquid crystal display (LCD) panel and a backlight module. The first slab is hinged with the second slab by using an electrical hinge assembly and therefore the first slab can be closed relative to the second slab, or open relative to the second slab at a desired angle. However, power transmission is needed between the first slab and the second slab. For example, the power provided by the battery in the first slab is needed to be transferred to the LCD panel and the backlight module in the second slab. Hence, there is an electrical connection existed between the first slab and the second slab.

Taiwan patent No. M315953 discloses an easy-layout hinge including a first holder and a second holder. The first holder and the second holder are hinged to each other and can be rotated relatively, and they connect with the first slab and the second slab respectively. The first holder has a shaft body and the shaft body has a cannular part. The cannular part is formed by penetrating the shaft body along its axis, and therefore, a conducting wire can be disposed through the cannular part. One terminal of the conducting wire is electrically connected with the first slab, and another terminal of the conducting wire is electrically connected with the second slab. However, making the shaft body cannular-shaped is a time consuming and laborious process so as to increase the production cost. In addition, the shaft body needs to provide the cannular part for containing the conducting wire so the radial dimension of the shaft body should maintain a certain size. Consequently, there is limitation on the demand of miniaturization.

U.S. Pat. No. 7,809,412 discloses a hinge assembly including a first holder and a second holder. The first holder and the second holder are hinged to each other and can be rotated relatively, and they connect with the first slab and the second slab respectively. The first holder has a shaft body and the shaft body has a seam and a flexible cable. The flexible cable is Π-shaped with two legs, in which one of the legs can selectively encompass the shaft body and electrically connect with the first slab, and the other of the legs can penetrate the shaft body through the seam to be electrically connected with the second slab. However, this kind of structure is achieved by configuring the flexible cable outside the shaft body, thus taking more space amid the first slab and the second slab. Besides, it will raise the chance of abrasion between the flexible cable and other elements thus speeding up the abrasion of the flexible cable and increase the possibility of causing short circuit and disconnection.

### SUMMARY OF THE INVENTION

Accordingly, the object of this invention is to provide an electrical hinge assembly and an electric device using the same in the hope of improving the degree of freedom on structure design, diminishing abrasion, increasing durability io and decreasing the possibility of causing short circuit and disconnection.

According to an aspect of the invention, an electrical hinge assembly for providing an electrically hinged connection between a first slab with a second slab. The electrical hinge assembly includes a first holder and a second holder. The first holder has a shaft body and the shaft body includes a central shaft and a conductive layer which covers the central shaft. The second holder has a tube body which can put on the shaft body and be rotatable relative to the shaft body.

In one embodiment of this invention, an insulating material covers the central shaft of the electrical hinge assembly.

In one embodiment of this invention, the shaft body of the electrical hinge assembly further includes a first insulating layer. The first insulating layer is accommodated between the conductive layer and the central shaft.

In one embodiment of this invention, the shaft body of the electrical hinge assembly further includes a second insulating layer. The second insulating layer covers the conductive layer.

In one embodiment of this invention, the shaft body of the electrical hinge assembly further includes a friction layer. The friction layer bears against an interior side of the tube body.

In one embodiment of this invention, the friction layer is formed by stretching out the central shaft along its radial direction. The friction layer and the central shaft form a slotting. The first insulating layer, the conductive layer and the second insulating layer are accommodated in the slotting.

In one embodiment of this invention, a friction surface of the friction layer is on a side that is back toward an exterior side of the central shaft. A radial distance between the second insulating layer and the central shaft is shorter than a radial distance between the friction surface and the central shaft.

In one embodiment of this invention, the first insulating layer covers the entire side surface of the central shaft and the conductive layer covers the entire side surface of the first insulating layer. The second insulating layer covers the entire side surface of the conductive layer and the friction layer covers the entire side surface of the second insulating layer.

In one embodiment of this invention, the second holder of the electrical hinge assembly has a fixed edge and the tube body includes a first tube piece and a second tube piece. The first tube piece is formed by stretching out the fixed edge and then surrounding the shaft body counterclockwise and a first opening is formed between an end of the first tube piece and the fixed edge. The second tube piece is formed by stretching out the fixed edge and then surrounding the shaft body clockwise and a second opening is formed between an end of the second tube piece and the fixed edge.

In one embodiment of this invention, the conductive layer of the electrical hinge assembly has a circuit printed thereon.

In addition, this invention sets forth an electric device that includes the foregoing electrical hinge assembly, the first slab and the second slab. The shaft body has a first end and a second end opposite to the first end, and the tube body puts on the shaft body between the first end and the second end. The first slab is fastened on the foregoing first holder and has the first electrical component which is electrically connected with the conductive layer of the first end. The second slab is fastened on the foregoing second holder and has the second electrical component which is electrically connected with the conductive layer of the second end. Wherein the first slab is hinged with the second slab and the first electrical component is electrically connected with the second electrical component.

In one embodiment of this invention, the electrical hinge assembly of the electric device further includes a first connector and a second connector. The first connector is electrically connected with the conductive layer located on the first end; and the second connector is electrically connected with the conductive layer located on the second end. The first electrical component is electrically connected with the first connector, and the second electrical component is electrically connected with the second connector.

In one embodiment of this invention, the first holder of the electric device further includes a first bearing plate and the first end of the shaft body is fastened on an end of the first bearing plate. The second holder further includes a second bearing plate and the tube body is fastened on an end of the second bearing plate. Wherein the first slab is fastened on the bottom side of the first bearing plate and the second slab is fastened on the top side of the second bearing plate.

This invention setting forth an electrical hinge assembly and electric device using the same, wherein by covering a conductive layer on the central shaft makes the shaft body itself possess conductive property, in this manner, improving the degree of freedom on structure design and diminishing abrasion, augmenting durability and decreasing the possibility of causing short circuit and disconnection.

### BRIEF DESCRIPTION OF THE DRAWINGS

The foregoing and other objects, features and advantages of the disclosure will be apparent and easily understood from a further reading of the following embodiments, claims and by reference to the accompanying drawings in which:

FIG. 1 is a schematic diagram illustrating an embodiment of an electrical hinge assembly according to the invention;

FIG. 2 is a drawing illustrating the first holder and the shaft body shown in FIG. 1;

FIG. 3 is a partially enlarged cross-sectional view of the shaft body shown in FIG. 1;

FIG. 4 is a partially enlarged cross-sectional view of another embodiment of the shaft body shown in FIG. 3; and

FIG. 5 is a schematic diagram illustrating an embodiment of an electric device according to the invention.

### DESCRIPTION OF THE PREFERRED EMBODIMENTS

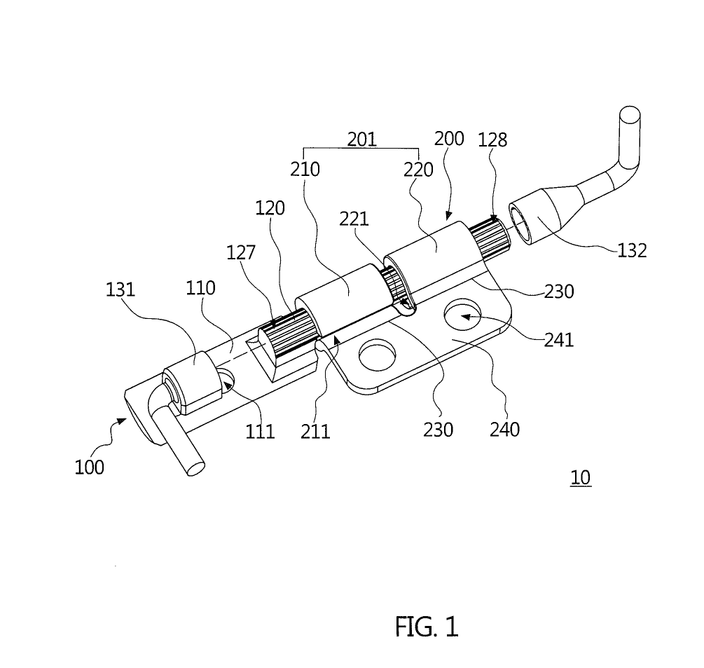

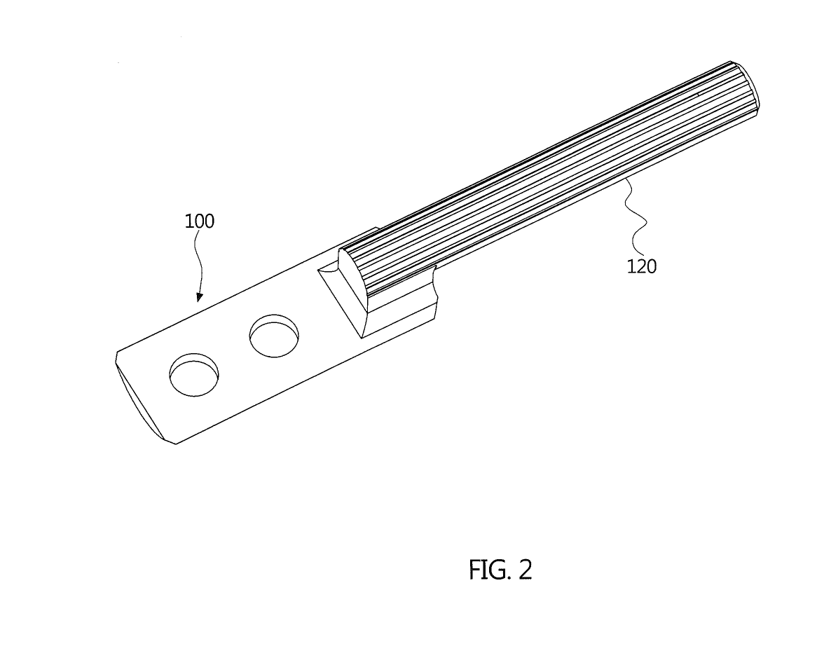

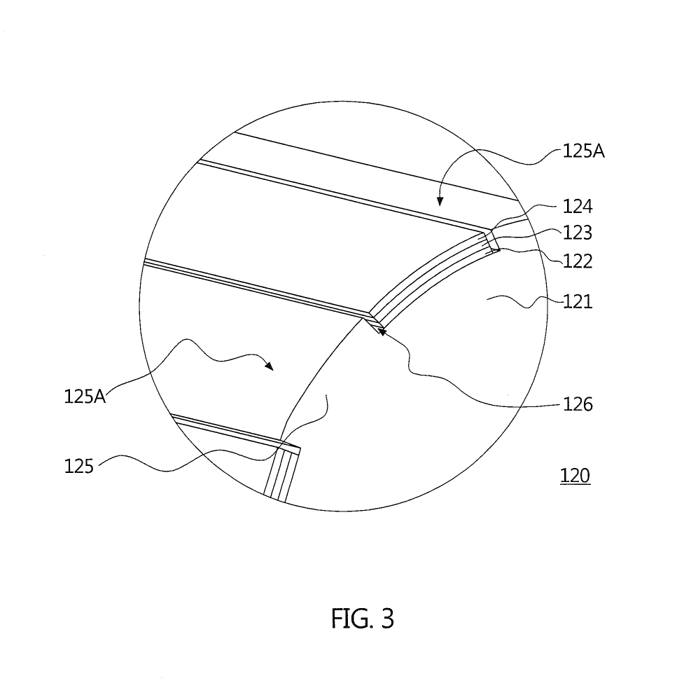

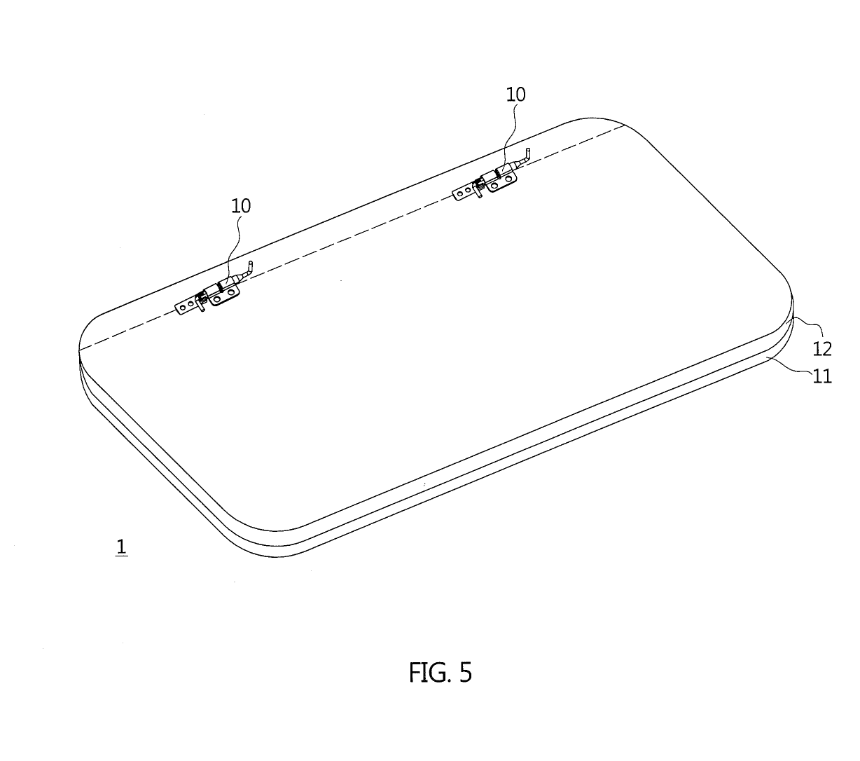

Please refer to FIG. 1 to FIG. 3 and FIG. 5 concurrently. FIG. 1 is a schematic diagram illustrating an embodiment of an electrical hinge assembly according to the invention. FIG. 2 is a drawing illustrating a first holder and a shaft body shown in FIG. 1. FIG. 3 is a partially enlarged cross-sectional view of the shaft body shown in FIG. 1. FIG. 5 is a schematic diagram illustrating an embodiment of an electric device according to the invention, in which the electric device uses the electrical hinge assembly shown in FIG. 1.

In this embodiment, the electric device 1 is, but not limited to, a laptop. The electric device 1 has a first slab 11 and a second slab 12. The first slab 11 has a first electrical component (not shown) which includes a computer component such as a motherboard and a central processing unit (CPU), a battery and an input device such as a keyboard. The second slab 12 has a second electrical component (not shown) which includes an LCD panel and a backlight module. The first slab 11 is hinged with the second slab 12 by using the electrical hinge assembly 10 and therefore the first slab 11 can be closed relative to the second slab 12, or open relative to the second slab 12 at a desired angle. The electrical hinge assembly 10 is further electrically connected with the first electrical component and the second component. In other words, the battery in the first slab 11 or an external power supply that is selectively connected with the first electrical component, are not only for providing power for the computer component and the input device in the first slab 11 but also for transferring power to the LCD panel and the backlight module in the second slab 12.

The electrical hinge assembly 10 is applied to providing an electrically hinged connection between the first slab 11 and the second slab 12. The electrical hinge assembly 10 includes a first holder 100 and a second holder 200 hinged to each other. The first holder 100 has a first bearing plate 110 and a shaft body 120, and there is a plurality of through-holes 111 on the first bearing plate 110. By using a corresponding fixture tool such as screw nails (not shown) to get them through the through-holes 111 and screw the first bearing plate 110 to the first slab 11, so that the first slab 11 can be fastened on the bottom side of the first bearing plate 110. The shaft body 120 has a first end 127 and a second end 128 opposite to the first end 127. The first end 127 is fastened on an end of the first bearing plate 110.

The shaft body 120 includes a central shaft 121 and the central shaft 121 is a cylinder formed by extending along an axis of the shaft body 120. The central shaft 121 is covered with layers in the sequence of a first insulating layer 122, a conductive layer 123 and a second insulating layer 124, in which the central shaft 121 can be made of conductive metal material. Therefore, covering the central shaft 121 with the first insulating layer 122 that has insulating property can avoid short circuit or unexpected electrical connection. In other embodiment, the central shaft can be made of non-conductive material. In this case, the first insulating layer can be eliminated. The first insulating layer 122 is covered with the conductive layer 123 which is applied to transferring current, and the conductive layer 123 can further have a circuit printed thereon (not shown). The conductive layer 123 is covered with the second insulating layer 124 that possesses insulating property.

The shaft body 120 further includes a friction layer 125 which is formed by stretching out the central shaft 121 along its radial direction. The friction layer 125 and the central shaft 121 form a slotting 126. In this embodiment, the shaft body 120 includes a plurality of friction layers 125, and each of them is separated by a predetermined interspace. Each interspace is stretching out along the axial direction of the shaft body 120 and the slotting 126 is formed by the predetermined interspace and the central shaft 121. The first insulating layer 122, the conductive layer 123 and the second insulating layer 124 are accommodated in the slotting 126. Each friction layer 125 has a friction surface 125A on its side that is back toward the exterior side of the central shaft 121. The friction surfaces 125A form a side surface of the shaft body 120. The radial distance between the second insulating layer 124 and the axis of the shaft body 120 is not longer than the radial distance between the friction surface 125A and the axis of the shaft body 120. Preferably, the radial distance between the second insulating layer 124 and the axis of the shaft body 120 is shorter than the radial distance between the friction surface 125A and the axis of the shaft body 120.

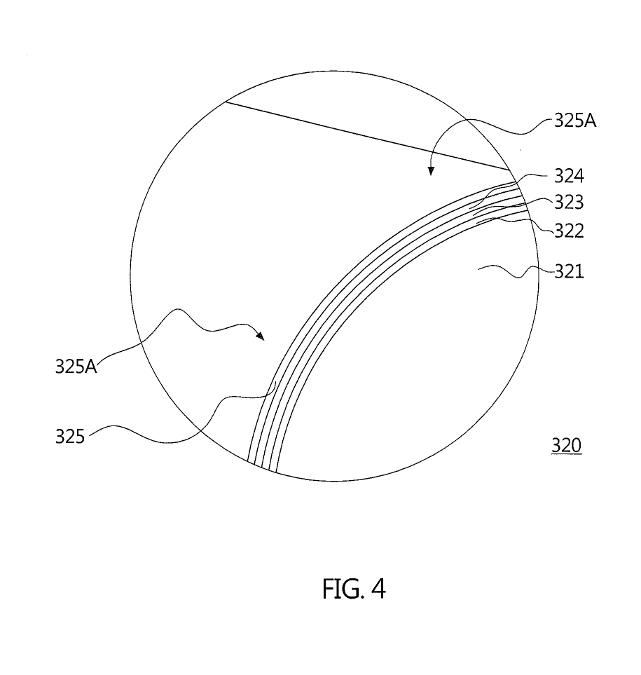

Please further refer to FIG. 4 concurrently. FIG. 4 is a partially enlarged cross-sectional view of another embodiment of the shaft body 120 shown in FIG. 3. Comparing to the shaft body 120, a shaft body 320 includes a central shaft 321 which is covered with layers in the sequence of a first insulating layer 322, a conductive layer 323, a second insulating layer 324 and a friction layer 325. The first insulating layer 322 covers the central shaft 321 by using the way of entire-side-surface covering, that is to say that the first insulating layer 322 covers the entire side surface of the central shaft 321. After that, the conductive layer 323 covers the entire side surface of the first insulating layer 322 and the second insulating layer 324 covers the entire side surface of the conductive layer 323, while the friction layer 325 covers the entire side surface of the second insulating layer 324. In other words, a friction surface 325A of the friction layer 325 is the side surface of the shaft body 320. As for the electrical connections, it is achieved by getting a first and a second connectors (not shown) penetrating through the friction layer 325 and the second insulating layer 324 to contact with the conductive layer 323; or removing parts of the friction layer 325 and the second insulating layer 324 corresponding to the electrical connections to expose the conductive layer 323 to contact with the first and the second connectors.

As shown in FIG. 1, FIG. 3 and FIG. 5, the electrical hinge assembly 10 further includes a first connector 131 and a second connector 132. The first connector 131 is electrically connected with the conductive layer 123 at the first end 127 and the second connector 132 is electrically connected with the conductive layer 123 at the second end 128. The first electrical component in the first slab 11 can be electrically connected with the first connector 131 via a corresponding interface; while the second electrical component in the second slab 11 can be electrically connected with the second connector 132 via a corresponding interface. By doing so, the first electrical component and the second electrical component are electrically connected.

The second holder 200 has a tube body 201 and a second bearing plate 240, and the tube body 201 is fastened on the side surface of the second bearing plate 240. Concretely speaking, the tube body 201 includes a first tube piece 210 and a second tube piece 220, and there is a fixed edge 230 on the side surface of the second bearing plate 240. The first tube piece 210 is formed by stretching out the fixed edge 230 and then surrounding the shaft body 120 counterclockwise, and a first opening 211 is formed between an end of the first tube piece 210 and the fixed edge 230. The second tube piece 220 is formed by stretching out the fixed edge 230 and then surrounding the shaft body 120 clockwise, and a second opening 221 is formed between an end of the second tube piece 220 and the fixed edge 230. There is a plurality of through-holes 241 on the second bearing plate 240. By using a corresponding fixture tool such as screw nails (not shown) to get them through the through-holes 241 and screw the second bearing plate 240 to the second slab 12, so that the second slab 12 can be fastened on the top side of the second bearing plate 240.

The first tube piece 210 and the second tube piece 220 put on the shaft body 120 between the first end 127 and the second end 128, and rotatable relative to the shaft body 120. The friction surface 125A of the shaft body 120 bears against the interior sides of the first tube piece 210 and the second tube piece 220. In other words, the first holder 100 and the second holder 200 are able to do relatively rotary movement with the tube body 201 via shaft body 120. In the process of rotary movement, friction forces occur by rubbing the interior sides of the first tube piece 210 and the second tube piece 220 with the friction surface 125A.

In this embodiment, the lengths of the first tube piece 210 and the second tube piece 220 are different, that is to say, unequal friction forces occur during the relatively clockwise rotary movement or counterclockwise rotary movement between the first holder 100 and the second holder 200. The advantage is that when an user wants to open the second slab 12 relatively to the first slab 11, the electrical hinge assembly 10 will create relatively low friction force in the purpose of making the second slab 12 open easier for the user; and, when the user wants to close the second slab 12 relatively to the first slab 11, the electrical hinge assembly 10 will create relatively high friction force in the purpose of avoiding closing too fast causing damage from the second slab 12 hitting the first slab 11. In other embodiment, the lengths of the first tube piece and the second tube piece can be equal, making it create consistent friction force whether the first holder and the second holder do relatively clockwise rotary movement or counterclockwise rotary movement.

To sum up, the electrical hinge assembly and the electric device using the same disclosed in the invention, it endues the shaft body itself with conductivity or transmission property by covering the conductive layer on the central shaft, so that there is no extra conducting wire needed in this invention. Moreover, the shaft body includes the friction layer and the slotting. The friction layer is applied to creating friction with the interior side of the tube body. The first insulating layer, the conductive layer and the second insulating layer have been accommodated in the slotting to avoid friction being occurred by rubbing the conductive layer with other elements. In this manner, this invention is not only improving the degree of freedom on structure design but also diminishing abrasion, increasing durability and decreasing the possibility of causing short circuit and disconnection.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

I claim:

1. An electrical hinge assembly for providing an electrically hinged connection between a first slab and a second slab, comprising:
a first holder having a shaft body, the shaft body including a central shaft and a conductive layer, the conductive layer covering the central shaft; and
a second holder having a tube body, the tube body putting on the shaft body and being rotatable relative to the shaft body.

2. The electrical hinge assembly according to claim 1, wherein an insulating material covers the central shaft.

3. The electrical hinge assembly according to claim 1, wherein the shaft body further includes a first insulating layer and the first insulating layer is accommodated between the conductive layer and the central shaft.

4. The electrical hinge assembly according to claim 3, wherein the shaft body further includes a second insulating layer and the second insulating layer covers the conductive layer.

5. The electrical hinge assembly according to claim 4, wherein the shaft body further includes a friction layer and the friction layer bears against an interior side of the tube body.

6. The electrical hinge assembly according to claim 5, wherein the friction layer is formed by stretching out the central shaft along its radial direction; the friction layer and the central shaft form a slotting; and, the first insulating layer, the conductive layer and the second insulating layer are accommodated in the slotting.

7. The electrical hinge assembly according to claim 6, wherein a friction surface of the friction layer is on a side that is back toward an exterior side of the central shaft, and a radial distance between the second insulating layer and the central shaft is shorter than a radial distance between the friction surface and the central shaft.

8. The electrical hinge assembly according to claim 5, wherein the first insulating layer covers an entire side surface of the central shaft; the conductive layer covers an entire side surface of the first insulating layer; the second insulating layer covers an entire side surface of the conductive layer; and, the friction layer covers an entire side surface of the second insulating layer.

9. The electrical hinge assembly according to claim 1, wherein the second holder has a fixed edge and the tube body includes:
is a first tube piece formed by stretching out the fixed edge and then surrounding the shaft body counterclockwise, and a first opening being formed between an end of the first tube piece and the fixed edge; and
a second tube piece formed by stretching out the fixed edge and then surrounding the shaft body clockwise, and a second opening being formed between an end of the second tube piece and the fixed edge.

10. The electrical hinge assembly according to claim 1, wherein the conductive layer has a circuit printed thereon.

11. An electric device comprising:
an electrical hinge assembly comprising:
a first holder having a shaft body, the shaft body including a central shaft and a conductive layer, the conductive layer covering the central shaft, and the shaft body has a first end and a second end opposite to the first end; and
a second holder having a tube body, the tube body putting on the shaft body between the first end and the second end and being rotatable relative to the shaft body;
a first slab fastened on the first holder and having a first electrical component which is electrically connected with the conductive layer of the first end; and
a second slab fastened on the second holder and having a second electrical component which is electrically connected with the conductive layer of the second end;
wherein, the first slab is hinged with the second slab and the first electrical component is electrically connected with the second electrical component.

12. The electric device according to claim 11, wherein the shaft body further includes a first insulating layer and the conductive layer covers the first insulating layer.

13. The electric device according to claim 12, wherein the shaft body further includes a second insulating layer and the second insulating layer covers the conductive layer.

14. The electric device according to claim 13, wherein the shaft body further includes a friction layer and the friction layer bears against an interior side of the tube body.

15. The electric device according to claim 14, wherein the friction layer is formed by stretching out the central shaft along its radial direction; the friction layer and the central shaft faun a slotting; and, the first insulating layer, the conductive layer and the second insulating layer are accommodated in the slotting.

16. The electric device according to claim 15, wherein a friction surface of the friction layer is on a side that is back toward an exterior side of the central shaft, and a radial distance between the second insulating layer and the central shaft is shorter than a radial distance between the friction surface and the central shaft.

17. The electric device according to claim 11, wherein the second holder has a fixed edge and the tube body includes:
a first tube piece formed by stretching out the fixed edge and then surrounding the shaft body counterclockwise, and a first opening being formed between an end of the first tube piece and the fixed edge; and
a second tube piece formed by stretching out the fixed edge and then surrounding the shaft body clockwise, and a second opening being formed between an end of the second tube piece and the fixed edge.

18. The electric device according to claim 11, wherein the conductive layer has a circuit printed thereon.

19. The electric device according to claim 11, wherein the electrical hinge assembly further includes a first connector and a second connector, and wherein the first connector is electrically connected with the conductive layer located on the first end; the second connector is electrically connected with the conductive layer located on the second end; the first electrical component is electrically connected with the first connector; and, the second electrical component is electrically connected with the second connector.

20. The electric device according to claim 11, wherein the first holder further includes a first bearing plate and the first end of the shaft body is fastened on an end of the first bearing plate, and wherein the second holder further includes a second bearing plate and the tube body is fastened on an end of the second bearing plate, wherein the first slab is fastened on a bottom side of the first bearing plate and the second slab is fastened on a top side of the second bearing plate.
